(19) United States
(12) Patent Application Publication
(10) Pub. No.: US 2023/0323155 A1
(43) Pub. Date: Oct. 12, 2023

(54) MULTI-FUNCTIONAL SILIZANE-BASED COATINGS AND MATERIALS

(71) Applicant: Powdermet, Inc., Euclid, OH (US)

(72) Inventors: Andrew Sherman, Mentor, OH (US); John Neukirchen, Euclid, OH (US)

(21) Appl. No.: 17/824,609

(22) Filed: May 25, 2022

Related U.S. Application Data
(60) Provisional application No. 63/328,072, filed on Apr. 6, 2022.

(51) Int. Cl. C09D 183/16; C09D 5/18; C09D 5/16; C09D 5/08; C09D 5/03; C09D 5/00; C09D 7/61; C09D 7/40; C09D 7/20; C09D 7/65; C09D 163/00; C09J 183/16; C09J 11/08; C09J 11/04

(52) U.S. Cl. CPC C09D 183/16; C09D 5/18; C09D 5/1675; C09D 5/08; C09D 5/032; C09D 5/033; C09D 5/002; C09D 7/61; C09D 7/67; C09D 7/70; C09D 7/20; C09D 7/65; C09D 163/00; C09J 183/16; C09J 11/08; C09J 11/04

(57) ABSTRACT

The present application is directed to a multifunctional coating for operation at temperatures in excess of 150° C., and up to 300+° C. The multifunctional coating includes: a) one or more polysilazanes (i.e., a group of silicon-based polymers) that include inorganic and/or organic functionalized polysilazane; b) one or more secondary polymeric additives one or more secondary polymeric additives (e.g., siloxane compounds and/or polysilane compounds); c) one or more optional functionalized nanoparticles and/or fillers; d) one or more optional additive polymers that include: i) Polysulfones (PSF) such as Polyethersulfone (PES) and/or Polyphenylene sulfide (PPS); ii) Polyimides (PI); iii) Polybenzimidazole (PBI); iv) Polybenzoxazoles (PBO); and/or v) fluoropolymers including Polytetrafluoroethylene (PTFE), Polyvinylidene fluoride or polyvinylidene difluoride (PVDF), Fluorinated ethylene propylene (FEP), and/or hexafluoropropylene (HFP); e) one or more optional additives (e.g., biocide, foaming agent, surface tension agent, pigment, curing agent, surface friction reducing agent, stabilizers, flexibilizers, inhibitors, flow control agents, anti-oxidants, degassing agents, dyes, coupling agent, dispersing agents, catalyst and/or hardeners; etc.); and f) one or more optional solvents; and which multifunctional coating is formulated such that it can optionally i) function as a high-temperature insulator, ii) have high elongation and/or improved hydrolytic stability, iii) have extreme weather resistance, iv) have high chemical resistance, v) have high impact and/or abrasion resistance, and/or vi) have improved thermal cycling resistance.

The present disclosure claims priority on U.S. Provisional Application Ser. No. 63/328,072 filed on Apr. 6, 2022, which is incorporated herein.

### FIELD OF THE DISCLOSURE

The present application is directed to a multifunctional coating for operation at temperatures in excess of 150° C., and up to 300+° C. The multifunctional coating includes polysilazane; secondary polymeric additive; optional functionalized nanoparticles and/or fillers; optional additive polymer; optional additive; and optional solvent; and which multifunctional coating is formulated such that it can optionally function as i) high-temperature insulators, ii) facilitate in high elongation and/or hydrolytic stability of the multifunctional coating, iii) extreme weather resistance, iv) high chemical resistance, v) impact and abrasion resistance, and/or vi) thermal cycling.

### BACKGROUND OF THE DISCLOSURE

There is an increasing demand for higher performance coatings which can: a) increase the lifetime of the coating and/or the material protected by the coating; b) reduce the cost of manufacture of the coating and/or material to be coated; c) enable higher operating temperatures of the coating and/or the coated material; and/or d) reduce the operating costs of the coating and/or coated material via reduced maintenance such as cleaning and reduced friction or wear such as flow resistance or pressure drop. Key in the oil and gas industry is enabling the operation of pipelines and/or drill assets (e.g., valves, plugs, seals, centralizers, expanders, sleeves, etc.) at higher temperatures and in corrosive environments, such as those containing H₂S, H₂SO₄, HCl, as well as saline environments a temperature from 100° C. to 400+° C. Marine coatings are required on various pipelines, drilling assets, docks, dock and building pilings, railings, etc., which prevent biofouling by inhibiting or preventing the growth and adhesion of marine organisms.

Improved electrical insulation is required for operation at 240° C. and above, such as class C insulation and magnet wire insulation, enabling higher temperature and higher current carrying operation of wires for applications including power transfer, electric motors, transformer and inductor cores, and other applications.

### SUMMARY OF THE DISCLOSURE

The present application is directed to a multifunctional coating for operation at temperatures in excess of 150° C., and up to 300+° C. The multifunctional coating includes: a) one or more polysilazanes (i.e., a group of silicon-based polymers) that include inorganic and/or organic functionalized polysilazane; b) one or more secondary polymeric additives (e.g., siloxane compounds and/or polysilane compounds); c) one or more optional functionalized nanoparticles and/or fillers; d) one or more optional additive polymers that include: i) Polysulfones (PSF) such as Polyethersulfone (PES) and/or Polyphenylene sulfide (PPS); ii) Polyimides (PI); iii) Polybenzimidazole (PBI); iv) Polybenzoxazoles (PBO); and/or v) fluoropolymers including Polytetrafluoroethylene (PTFE), Polyvinylidene fluoride or polyvinylidene difluoride (PVDF), Fluorinated ethylene propylene (FEP), and/or hexafluoropropylene (HFP); e) one or more optional additives (e.g., biocide, foaming agent, surface tension agent, pigment, curing agent, surface friction reducing agent, stabilizers, flexibilizers, inhibitors, flow control agents, anti-oxidants, degassing agents, dyes, coupling agent, dispersing agents, catalyst and/or hardeners; etc.); and f) one or more optional solvents; and which multifunctional coating is formulated such that it can optionally i) function as a high-temperature insulator, ii) have high elongation and/or improved hydrolytic stability, iii) have extreme weather resistance, iv) have high chemical resistance, v) have high impact and/or abrasion resistance, and/or vi) have improved thermal cycling resistance. When the multifunctional coating is a high-temperature insulators, such multifunctional coating can be used to a) act as thermal insulators, thereby reducing the high exposure to temperature on the overlying layers, and therefore increasing thermal efficiency of the system while providing the necessary anti-corrosion protection, and/or b) act as a thermal insulator to the underlying layer(s), thereby serving to reduce the cold exposure temperature of the sea water, while possessing the physical properties necessary to resist damage during installation and service.

In one non-limiting aspect of the present disclosure, the multifunctional coating can be formulated to resist cracking, delamination, or otherwise maintains integrity from bending forces similar to those experienced in pipelines, downhole OCTG (oil country tubular goods), SAGD (steam-assisted gravity drainage) tubulars, lay barge including reel installation, directional drilled pipe installations. The coating composition can be formulated to resist cracking, delamination, or otherwise maintain integrity from bending forces similar to those experienced in above ground or suspended power lines, high tension cables, and similar to resist ice buildup created by adverse weather conditions. The coating composition may be formulated to resist cracking, delamination, or otherwise maintain integrity due to thermal shock or extreme temperature changes.

In one non-limiting aspect of the present disclosure, the multifunctional coating possesses properties that are highly useful in withstanding exposure in a number of harsh environments, and/or resistant to a number of mechanical and/or chemical attacks. The multifunctional coating is especially useful where operation temperatures are in excess of 150° C. and up to 270° C. (e.g., 151-300° C. and all values and ranges therebetween) or more is required.

In another and/or alternative non-limiting aspect of the present disclosure, the multifunctional coating can optionally be useful for high temperature deep water pipeline protection. In particular, the multifunctional coating is especially useful in harsh or aggressive environments such as those experienced in a deep-water oil and gas extraction environment and are referenced as an example of its advanced performance and multiple use capability.

In another and/or alternative non-limiting aspect of the present disclosure, the multifunctional coating can optionally be used to coat the exterior and/or interior of oil and gas pipe. The interior of the oil and gas pipe, including deep sea and ultra-deep sea oil, gas flow line and riser pipe, and on-shore pipe and tube which includes down hole, extraction, gathering, infield, and transport pipe, is exposed to high temperatures, but also exposed to corrosive chemistries and particle abrasion at fairly high line pressures. In most cases, protective coatings are not resistant or can only provide limited performance in these environments. As a result, operators are faced with using a stainless steel and/or high-nickel alloy (corrosion resistant alloy—CRA) clad or lined pipe at a much greater cost and difficulty. An object of the present disclosure is to provide a multifunctional coating with the ability to resist very high temperatures (e.g., above 170° C.) coupled with the appropriate additives to resist the corrosive chemical solutions and wet particle abrasion. The multifunctional coating of the present disclosure displays the resistance and durability similar to a fluoropolymer with the strength of a ceramic. As a result, this performance targeted multifunctional coating can replace most applications that require stainless steel and/or high-nickel alloy (CRA) clad or lined pipe at nearly a quarter of the cost and can be supplied in one-third the delivery time of stainless steel and/or high-nickel alloy (CRA) clad or lined pipe with little sacrifice in performance and longevity as compared to stainless steel and/or high-nickel alloy (CRA) clad or lined pipe. As such, standard pipe (e.g., steel pipe, carbon steel pipe, aluminum alloy pipe, etc.) can be coated (interior coating and/or exterior coating) with the multifunctional coating of the present disclosure to form a coated pipe that has the same or similar high-temperature and corrosion resistant-properties of more expensive stainless steel and/or high-nickel alloy (CRA) clad or lined pipe.

In another and/or alternative non-limiting aspect of the present disclosure, the multifunctional coating can optionally be used on the exterior surface of boat hulls. In recent years, environmental regulation coupled with demand for higher hydrodynamic performance has greatly impacted the conventional ship hull and bottom coatings market. Advanced next generation coating technologies are in high demand as drag caused by the build-up of marine growth has a major effect on fuel cost and transit speed. The multifunctional coating can optionally include additives and chemistry adjustments including a non-leaching biocide where, upon curing, creates an ultra-hard, ultra-smooth surface, and optionally forms a bioresistant surface that resists biological growth on the surface of the coating, and is extremely useful as a high-performance release coating for marine vessels.

In another and/or alternative non-limiting aspect of the present disclosure, the multifunctional coating can optionally be used on the interior and/or exterior surfaces of rail hopper cars, silos and/or tanks that transport and store crushed minerals, grain, plastic pellets, etc., that are highly erosive due to their course nature and the bulk weight that presses and rubs on the surface during transport and/or storage. Most current abrasion-resistant coating materials are unable to withstand the dynamic conditions, or include components that are toxic and/or can contaminate the abrasive material. Also, this industry uses a labor intensive and inordinately expensive process of installing sheet materials that are fastened or glued to the surface of rail hopper cars, silos and tanks.

In another and/or alternative non-limiting aspect of the present disclosure, the multifunctional coating has the ability to resist high abrasion and provide superior non-stick properties, while maintaining its properties long term in a dynamic flexing environment.

In another and/or alternative non-limiting aspect of the present disclosure, the multifunctional coating includes one or more polysilazanes (i.e., a group of silicon-based polymers) that include inorganic and/or organic functionalized polysilazane. In one non-limiting embodiment, the polysilazane content in the multifunctional coating formulation is at least 3 wt. % (e.g., 3-50 wt. % and all values and ranges therebetween). In one non-limiting embodiment, the polysilazane content in the multifunctional coating formulation is 3-40 wt. %. In another non-limiting embodiment, the polysilazane content in the multifunctional coating formulation is 20-40 wt. %. In another non-limiting embodiment, the polysilazane content in the multifunctional coating formulation constitutes the largest weight percent component of the multifunctional coating after the multifunctional coating is cured and/or hardened. Non-limiting examples of polysilazanes include trialkoxysilyl substituted polymethyl/polydimethylsilazane or propyltriethoxysilyl-substituted polymethyl(hydro)/polydimethylsilazane. The polysilazane may or may not be modified. When the polysilazane is modified, it can optionally be modified by one or more organic additions and siloxane compounds and/or polysilane compounds, which additions can be used to modify its surface energy, interaction and compatibility with siloxane, polysilane and/or organic polymers. The polysilazane may optionally be partially dehydrogenated to increase its molecular weight and reduce porosity when applied in thicker coatings. The polysilazane can optionally be solubilized in a solvent or used as a thermoplastic prior to thermal, UV, IR, or chemical curing with a catalyst. The polysilazane can optionally be fluorine substituted. Non-limiting functionalized polysilazanes included in the multifunctional coating can include, but is not limited to, an organic polysilazane such as Durazone 1500™ fast cure, Durazone 1800™ fast cure and their partially dehydrogenated derivatives. The polysilazane may be partially dehydrogenated to increase its molecular weight, and reduce porosity when applied in thicker coatings, and then can be solubilized in a solvent or used as a thermoplastic prior to curing.

In another and/or alternative non-limiting aspect of the present disclosure, the multifunctional coating includes one or more secondary polymeric additives. Non-limiting examples of secondary polymeric additives include siloxane compounds and polysilane compounds. The content of the secondary polymeric additive in the multifunctional coating is at least 0.1 wt. %. Generally, the content of the secondary polymeric additive in the multifunctional coating is 0.1-50 wt. % (and all values and ranges therebetween). In one non-limiting embodiment, the content of the secondary polymeric additive in the multifunctional coating is 0.1-40 wt. %. In another non-limiting embodiment, the content of the secondary polymeric additive in the multifunctional coating is 0.2-30 wt. %. The one or more siloxane compound and/or polysilane compound additions can be used to modify the surface energy, interaction and compatibility of the polysilazane with organic polymers, including siloxane and/or polysilane compounds. Non-limiting examples of siloxane compounds and polysilane compounds include TEOS (Tetraethyl-orthosilicate), MTES (Methyltriethoxysilane), GPTMS (Glycidyloxypropyltrimethoxysilane), APTES ((3-Aminopropyl) triethoxysilane), DMODS (Dimethyl octadecylsilane), MTMS (Trimethoxymethylsilane), Methylvinylsiloxanes, 1,3-divinyltetramethyldisiloxane, 1,3,5-trivinyl-1,3,5-trimethylcyclotrisiloxane, 1,3,5,7-tetravinyl-1,3,5,7-tetramethylcyclotetrasiloxane, poly(dimethylsilylene), cyclopolysilanes, alkyltrihalosilane, trihalosilanes [e.g., phenyltrichlorosilane, tertiary butyltrichlorosilane, dodecyltrichlorosilane, etc.], poly(ethylene oxide-)-poly(1, 1-dimethyl-2, 2-dihexyldisilene), and poly(dimethylsilanediyl).

In another and/or alternative non-limiting aspect of the present disclosure, the multifunctional coating optionally includes one or more fillers. The one or more optional fillers can be used to optionally function to facilitate in forming a multifunctional coating that i) has high-temperature insulator properties that can be used to a) act as thermal insulators, thereby reducing the high exposure to temperature on the overlying layers, and therefore increasing thermal efficiency of the system while providing the necessary anti-corrosion protection, and/or b) act as a thermal insulator to the underlying layer(s), thereby serving to reduce the cold exposure temperature of the sea water, while possessing the physical properties necessary to resist damage during installation and service, ii) has high elongation and/or hydrolytic stability, iii) has improved weather resistance, iv) has improved chemical resistance, v) has improved impact and/or abrasion resistance, and/or vi) has improved thermal cycling. The one or more fillers that can also or alternatively function to tie the inorganic and organic phases of the multifunctional coating together so as a to stabilize the structure of the multifunctional coating, while also increasing thermal conductivity, dielectric strength and/or mechanical strength of the multifunctional coating. The one or more fillers in the multifunctional coating can optionally be high surface area fillers. Such high surface area fillers, when used, can be used to reduce coating cost, modify coating viscosity, modify coating thicknesses, and/or modify curing properties of the multifunctional coating. One non-limiting use of the one or more fillers in the multifunctional coating is to increase thermal conductivity of the multifunctional coating. Fillers that can be used to: a) increase thermal conductivity in the multifunctional coating include, but are not limited to, boron nitride nanosheets (BNNS); and/or b) modify a surface area and/or surface energy include, but are limited to, F-POSS (Fluorinated Polyhedral Oligomeric Silsesquioxanes) additions, fluoropolymer additions, nanoparticles additions with modified surfaces, such as those with F-POSS, or other superhydrophobic coatings. The inclusion a filler that includes nanoparticles in the multifunctional coating can optionally reduce contact angles by at least 5° and, generally, by 5°-30° or more (and all values and ranges therebetween). Nanoparticle fillers and/or other types of fillers can be used to increase thermal conductivity, modify surface area and/or surface energy, reduce contact area, reduce micro and macro biofouling, reduce or eliminate adhesion of marine growth, add surface texture, enhance toughness, enhance abrasion resistance, increase impact resistance, modify density, increase thermal insulation, improve chemical resistance, and/or increase hardness of the multifunctional coating. For examples, the includes of the one or more fillers in the multifunctional coating can be used to form a multifunctional coating having one or more of a) a high thermal conductivity (greater than 0.2 W-m-K [e.g., 0.21-2 W-m-k and all values and ranges therebetween], or greater than 0.5 W-m-K), b) a high dielectric breakdown strength above 500 V/mill (e.g., 501-1200 V/mill and all values and ranges therebetween), or above 800V/mil, c) a low flow resistance that is lower than epoxy (e.g., 5-70% lower flow resistance than epoxy and all values and ranges therebetween), at least 30% lower flow resistant than epoxy, d) a contact angle that is greater than 90° (e.g., 90.1°-160° and all values and ranges therebetween for a hydrophobic coating) greater than 110° for a hydrophobic coating, less than 50° (e.g., 10°-49.9° and all values and ranges therebetween for a hydrophilic coating, e) an oil contact angle of greater than 100° (100.1°-160° and all values and ranges therebetween), f) a reduced marine growth or adhesion of at least 20% (e.g., 20-90% and all values and ranges therebetween), a reduced marine growth or adhesion of at least 30%, a reduced marine growth or adhesion of at least 50% or more, and/or g) a scratch resistance pencil hardness (ASTM D3363) of 6N or greater (e.g., 6N-15N and all values and ranges therebetween), 9N or greater. Other functionalities that can be modified by the one or more fillers include improved surface finish, improved adhesive and/or film stability, improved elasticity, improved flexibility, improved crack resistance, improved impact resistance, improved ductility, improved strength, improved toughness, improved elongation, improved hardness, improved corrosion resistance, improved chemical resistance, improved abrasion resistance, improved hydrolytic stability, modified density, improved omniphobic properties, improved hydrophobic properties, reduce leaching of biocide, improved anti-static properties, improved thermal isolative properties, improved thermal conductiveness, improved thermochromic properties, improved nonstick properties, improved self-cleaning foul release properties, improved anti-fouling properties, improved anti-static properties, improved thermal conductivity properties, improved thermal insulating properties, improved anti-seize properties, improved anti-bacterial properties, improved radar absorbing properties, and/or improved EMF (electromagnetic field) shielding properties.

In another and/or alternative non-limiting aspect of the present disclosure, the content of the filler in the multifunctional coating, when used, is at least 2 wt. % (e.g., 2-60 wt. % and all value and ranges therebetween). In one non-limiting embodiment, the filler content in the multifunctional coating formulation is 5-60 wt. %. In another non-limiting embodiment, the filler content in the multifunctional coating formulation is greater than the content of polysilazane in the multifunctional coating and constitutes the largest component of the multifunctional coating after the multifunctional coating is hardened and/or cured. In another non-limiting embodiment, the filler content in the multifunctional coating formulation is less than the content of polysilazane in the multifunctional coating and optionally constitutes the second largest component of the multifunctional coating after the multifunctional coating is hardened and/or cured.

In another and/or alternative non-limiting aspect of the present disclosure, the filler included in the multifunctional coating includes one or more nanoparticles, nanosheets, and/or nanofibers filler (e.g., one or more nanoparticles, nanosheets, and/or nanofibers [e.g., nanoparticles of fluorinated polyhedral oligomeric silsesquioxane (F-POSS), nanoparticles of graphene, nanoparticles of graphene oxide, fumed silica nano-ceramics, boron nitride nanosheets, carbon nanotubes, nanoclays, nano-metal powers [e.g., Al powder, Mn powder, Ni powder, Fe powder, carbon powder, etc.], nano-silica, exfoliated nano-fillers, carbon nanofibers, boron nanofibers, nanofibers including conductive nanofibers, nanoparticles of fluorinated silane, nanoparticles of silicone, ceramic nano-spheres, carbon powders, B₄C, etc.). The nanoparticles, nanosheets and nanofibers have a size wherein at least one dimension is 1-10,000 nm (and all values and ranges therebetween). In one non-limiting embodiment, nanoparticles, nanosheets and nanofibers have a size wherein at least one dimension is less than 100 nm (e.g., 1-99.9 nm and all values and ranges therebetween). In another non-limiting embodiment, the filler in the multifunctional coating formulation includes nanoparticles, and the content of the nanoparticles in the multifunctional coating is at least 0.1 wt. %. In another non-limiting embodiment, the filler in the multifunctional coating formulation includes nanoparticles, and the content of the nanoparticles in the multifunctional coating is 0.1-30 wt. % (and all values and ranges therebetween). In another non-limiting embodiment, the filler in the multifunctional coating formulation includes nanoparticles, and the content of the nanoparticles in the multifunctional coating is 0.5-10 wt. %. In one non-limiting embodiment, the use of nanofillers in the multifunctional coating can be used to formed, upon the curing of the multifunctional coating, a thin, ultra-hard, ultra-smooth surface with enhanced nonstick/release properties.

In another and/or alternative non-limiting aspect of the present disclosure, the filler included in the multifunctional coating includes one or more ceramic spheres. Non-limiting ceramic spheres includes hollow and/or solid ceramic spheres (e.g., alumina spheres, alumina-zirconia spheres, aluminum nitride spheres, and aluminum silicate spheres; boron carbide spheres, boron nitride spheres; cordierite spheres, forsterite spheres; carbon spheres, graphite spheres; magnesia spheres, metal boride spheres, silica spheres, and silicon carbide spheres, zircon spheres, zirconia spheres, zirconium phosphate spheres, etc. The size of the ceramic spheres can be 5 nm to 1 mm (and all values and ranges therebetween). In one non-limiting embodiment, the ceramic spheres have a size wherein at least one dimension is 1-10,000 nm (and all values and ranges therebetween). In another non-limiting embodiment, the filler in the multifunctional coating formulation includes ceramic spheres, and the content of the ceramic spheres in the multifunctional coating is at least 0.1 wt. %. In another non-limiting embodiment, the filler in the multifunctional coating formulation includes ceramic spheres, and the content of the ceramic spheres in the multifunctional coating is 0.1-40 wt. % (and all values and ranges therebetween). In another non-limiting embodiment, the filler in the multifunctional coating formulation includes ceramic spheres, and the content of the ceramic spheres in the multifunctional coating is 0.5-30 wt. %.

In another and/or alternative non-limiting aspect of the present disclosure, the multifunctional coating can optionally include one or more additive polymers. Such additive polymers include i) Polysulfones (PSF) such as Polyethersulfone (PES) and/or Polyphenylene sulfide (PPS); ii) Polyimides (PI); iii) Polybenzimidazole (PBI); iv) Polybenzoxazoles (PBO); and/or v) fluoropolymers including Polytetrafluoroethylene (PTFE), Polyvinylidene fluoride or polyvinylidene difluoride (PVDF), Fluorinated ethylene propylene (FEP), and/or hexafluoropropylene (HFP). In one non-limiting embodiment, the additive polymer can optionally function as a flexibilizer. When the additive polymer is included in the multifunctional coating, the additive polymer constitutes about 1-45 wt. % (and all values and ranges therebetween) of the multifunctional coating. In one non-limiting embodiment, the additive polymer constitutes about 2-40 wt. % of the multifunctional coating. In another non-limiting embodiment, the additive polymer constitutes about 2-15 wt. % of the multifunctional coating.

In another and/or alternative non-limiting aspect of the present disclosure, the multifunctional coating can optionally include one or more additives (e.g., biocide, defoaming agent, surface tension agent, pigment and/or dye, curing agent, surface friction reducing agent, stabilizer, inhibitor, catalyst, hardener, flow control agent, anti-oxidant, degassing agent, dispersing agents, coupling agent, etc.). The additives can be used to a) assist in flow, b) reduce or eliminate foaming, c) control surface tension, d) add color (e.g., pigment, etc.), e) facilitate in the curing of the multifunctional coating (e.g., curing agent, etc.), f) improve antimicrobial resistance (e.g., biocide additive, etc.), g) reduce foaming, h) reduce surface friction reducing agent, i) stabilizer coating, j) improve flexibility of coating, k) inhibitor certain reactions, 1) catalyze coating reactions, m) harden and/or cure coating, n) inhibit fouling of coating, and/or o) improve dispersement of components in coating. The optional additives, when used, constitute at least 1 wt. % of the multifunctional coating. Generally, the content of the optional additive in the multifunctional coating, when used, is 0.1-40 wt. % (and all values and ranges therebetween). In one non-limiting embodiment, the content of the optional additive in the multifunctional coating is 2-30 wt. %.

In another and/or alternative non-limiting aspect of the present disclosure, the multifunctional coating optionally includes biocidal agent such as, but not limited to, nano-selenium (n-Se), nano-CuO₂, nano copper, nano silver, nano antimony, nano boron, nano tin, nano zinc, and/or other biocidal agents to enhance resistance to organic growth on the surface of the multifunctional coating. The use of the biocide agent can reduce flow resistance over the surface of the multifunctional coating. For example, the inclusion of biocide agent in the multifunctional coating can result in a decrease in flow resistance over the surface of the multifunctional coating by 20-90% (and all values and ranges therebetween; 30-60+%), for periods of 2-24 months (and all values and ranges therebetween; 8-24 months), and such surface can be maintained over such time periods with only remedial scraping, brushing, water jetting, or high-speed flow operations. In one non-limiting embodiment, when the multifunctional coating includes biocide, the biocide constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include surface friction reducing agent (e.g., polymer additives [e.g., a lower molecular weight Polydimethylsiloxane (PDMS) and/or other silicone polymer, etc.]. etc.) to enhance the multifunctional coating's resistance to biofouling. The nanostructured chemistry in the multifunctional coating can be used to provide slow release and diffusion of the lower molecular weight silicone oil to enhance the lifetime of the low friction coatings. In one non-limiting embodiment, when the multifunctional coating includes surface friction reducing agent, the surface friction reducing agent constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include biocide agent in combination with low friction material (e.g., silicone, silicone combined with fluoropolymer elastomer, silicone combined with fluoropolymer elastomer and nanoparticle fillers, a lower molecular weight Polydimethylsiloxane (PDMS), etc.) to create a surface texture on the multifunctional coating that can reduce marine growth by 10-99.9% (and all values and ranges therebetween, and typically 30-95+%, and also or alternatively reduce adhesion of barnacles and other marine growth by 10-90% (and all values and ranges therebetween, and typically 30-80+%, thereby enabling easy removal and cleaning of such marine growth during motion of the marine vehicle (e.g., boat, etc.), or by external means such as pressurized water flow or mechanical sweeping or abrasive removal techniques. In one non-limiting formulation, the multifunctional coating that includes biocide, PSZ (polysilazane), FP (fluoropolymer), NMB (nanomicrobial), silicone, and (PDMS). In one non-limiting embodiment, when the multifunctional coating includes biocide agent, the biocide agent constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include defoaming agent that is used to reduce the formation of foam and bubbles within the applied polymer. Non-limiting examples of defoaming agent include are mineral oil, silicone oil, hydrophobic polyol, hydrophobic silica, and/or ethylene-bis-stearamide. In one non-limiting embodiment, when the multifunctional coating includes defoaming agent, the defoaming agent constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include surface tension agent that is used to reduce tension in the surface layer, thereby increasing its spreading and wetting properties. Non-limiting examples of surface tension agent include organomodified silicones and fluorinated polyacrylates. In one non-limiting embodiment, when the multifunctional coating includes surface tension agent, the surface tension agent constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include pigment. The pigment can optionally be inorganic high temperature resistant powder additives that give color to the multifunctional coating for finished appearance and/or contrast in an application. The pigment can optionally have one or more properties of high weathering stability, chemical stability, non-toxicity, and/or easily dispersable. Non-limiting examples of pigments include cobalt-blue, zinc iron-yellow, titanium chrome-black, cerium-red, and cobalt chromite-green. In one non-limiting embodiment, when the multifunctional coating includes pigment, the pigment constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include curing agent, catalysts, and/or hardeners to create, induce, and/or facilitate a chemical reaction within the multifunctional coating to cause the multifunctional coating to cure and/or harden. The type and amount of curing agent, catalyst, and/or hardener is dependent the chemical make-up of the multifunctional coating which is dictated by the required properties, method of application, environment, required cure cycle to name a few considerations. Non-limiting examples of curing agent, catalyst, and/or hardener include dicumyl peroxide, DBU, amine catalysts, tin catalysts, platinum catalysts, UV cure agents, and/or phenolics. In one non-limiting embodiment, when the multifunctional coating includes curing agent, catalysts, and/or hardeners, the curing agent, catalysts, and/or hardeners constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include stabilizer that can be used to buffer interactions between additives to minimize degradation, and/or to help counter the detrimental impacts from an exterior source. Non-limiting examples of buffer incudes hindered amine light stabilizers (HALS), UV absorbers, resistant co-binders, and phosphite ester. In one non-limiting embodiment, when the multifunctional coating includes stabilizer, the stabilizer constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include inhibitor that can be used to obstruct the formation of corrosion or deterioration of the surface of the multifunctional coating. The inhibitor can also or alternatively be used to control and/or stabilize the multifunctional coating from degradation. Non-limiting examples of inhibitor includes zinc dust and/or zinc pigments. In one non-limiting embodiment, when the multifunctional coating includes inhibitor, the inhibitor constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include flow control agent that can be used to reduce the surface tension of the particles in the multifunctional coating (e.g., powder particles, nanoparticles, etc.) as they melt, flow and/or coalesce during the mixing, curing and/or hardening of the multifunctional coating. Such flow control agents can be used to facilitate in the bonding of the multifunctional coating to a substrate and/or form desired surface features (e.g., smooth surface, rough surface, non-porous surface, porous surface, etc.) as the multifunctional coating hardens and/or cures. Non-limiting examples of flow control agent include acrylates, silicones, poly-siloxanes including polyether and polyester modified, poly (vinyl butyral), cellulose acetate/butyrate, acrylate copolymers, benzoin and non-yellowing agent additives, and/or antistatic agents (e.g, quaternary ammonium salts (cationic), alkyl sulfonates (anionic) based on fatty-acid derivatives, etc.). In one non-limiting embodiment, when the multifunctional coating includes flow control agent, the flow control agent constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include antioxidant to inhibit or prevent discoloration and/or loss of mechanical properties during exposure to environmental and/or elevated thermal conditions. Non-limiting examples of antioxidant include phenolic compounds that may include phosphites and thiosynergists depending upon the polymer formulation and service environment. In one non-limiting embodiment, when the multifunctional coating includes antioxidant, the antioxidant constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include degassing agent that is used to scavenge oxygen and/or promote dissolution of gases in order to minimize bubbles, pinholes, and related surface forming defects in the multifunctional coating. One non-limiting example of a degassing agent includes benzoin. In one non-limiting embodiment, when the multifunctional coating includes degassing agent, the degassing agent constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include dispersing agent used to reduce interfacial tension between particulates and fillers in the multifunctional coating to thereby keep such materials evenly dispersed in the multifunctional coating during mixing and subsequent curing and/or hardening. Non-limiting examples of dispersing agent include fluorosurfactants, and polyether siloxanes. In one non-limiting embodiment, when the multifunctional coating includes dispersing agent, the dispersing agent constitutes at least 0.01 wt. % (e.g., 0.01-20 wt. % and all values and ranges therebetween) of the multifunctional coating.

In another and/or alternative non-limiting aspect of the present disclosure, the multifunctional coating can optionally include coupling agent that is used to promote adhesion and/or the coupling between dissimilar materials such as organic and inorganic components in the multifunctional coating, reinforce compatibility between fillers and polymer chemistry in the multifunctional coating, and/or serve to promote melt blending of two or more compounds including insoluble compounds at high temperatures in the multifunctional coating. The coupling agent can be introduced into the multifunctional coating as an additive and/or used to surface treat one or more fillers (to functionalize the filler) prior to mixing the filler in the multifunctional coating. Non-limiting examples of coupling agent include organosilane, titanates, and zirconates. In one non-limiting embodiment, when the multifunctional coating includes coupling agent, the coupling agent constitutes at least 0.01 wt. % (e.g., 0.01-20 wt. % and all values and ranges therebetween) of the multifunctional coating.

In another and/or alternative non-limiting aspect of the present disclosure, the multifunctional coating can include a solvent to facilitate in the mixing together of the components of the multifunctional coating and/or to facilitate in the application of the multifunctional coating to a surface. The solvent, when used, generally constitutes at least 1 wt. % of the multifunctional coating prior to the curing and/or hardening of the multifunctional coating. Generally, the solvent constitutes 1-50 wt. % (and all values and ranges therebetween) of the multifunctional coating prior to the curing and/or hardening of the multifunctional coating. In one non-limiting embodiment, the multifunctional coating composition includes one or more liquid organic solvents for the purpose of dissolving or dispersing the components used in the formulation while helping to create a uniform blended composition. Upon application by various means, the solvent serves a number of positive purposes such as helping to create a uniform film at the desired thickness, helping to wet the surface advancing adhesion, and helping to control film forming properties during curing and/or hardening. Although a wide variety of solvents may be incorporated into the multifunctional coating, non-limiting suitable solvents are those that contain no water and no reactive groups such as hydroxyl or amine groups. Non-limiting examples of solvents that can be used include hexane; heptane; benzene; toluene; esters, such as methyl acetate, n-butyl acetate, tert-butyl acetate, isobutyl acetate, sec-butyl acetate, ethyl acetate, amyl acetate, pentyl acetate, 2-methyl butyl acetate, isoamyl acetate, n-propyl acetate, isopropyl acetate, ethylhexyl acetate; ketones, such as acetone or methyl ethyl ketone; ethers, such as tetrahydrofuran, dibutyl ether; branched-chain alkanes (isoparaffins); halogenated hydrocarbons; and mono and polyalkylene glycol dialkyl ethers (glymes) or mixtures of these solvents. In one specific formulation, the solvent includes a low moisture organic solvent such as ethyl acetate, butyl acetate, propylene glycol methyl ether acetate, or a fluoruos solvent.

In another and/or alternative non-limiting aspect of the present disclosure, the multifunctional coating can be applied at thicknesses of at least 0.5 mils (e.g., 0.5-50 mils and all values and ranges therebetween). Generally, the multifunctional coating is applied at a thickness of 0.5 mils (12.5 microns) to 20 mils+(500 microns+) as a single finished coat, or from the application of multiple coatings. The multifunctional coating can be applied by using conventional paint application methods. The multifunctional coating has an applied thickness that can vary based upon several variables including intended service, surface type, additives type, and/or solids content. The thickness of the multifunctional coating after curing is generally at least 0.1 mils (e.g., 0.1-100 mills and all values and ranges therebetween), and typically 0.2-20 mils.

In another and/or alternative non-limiting aspect of the present disclosure, the multifunctional coating can have thermal insulating properties that is suitable for classes R (220° C.), C (240° C.+) and greater than 250+(250+° C.) insulation. In one non-limiting examples, the multifunctional coating was subjected to testing that involved coupling high thermal conductivity (greater than 4000 W/m-K) with boron nitride nanosheets (BNNs) in inorganic-organic hybrid films to achieve at 250° C.+, high dielectric strength, high thermal conductivity, low-permittivity insulating films.

In another and/or alternative non-limiting aspect of the present disclosure, the multifunctional coating includes composites of inorganic polysilazanes (600-1000° C. temperature capability an all values and ranges therebetween) with high-temperature polymers (Polyimide (PI), polybenzimidazole (PBI), and/or polybenzoxazole (PBO)). For example, a baseline system of polyimide with BNNs was expected to have thermal stability to 350° C.+. Improved performance (breakdown, adhesion, thermal conductivity, surface energy, hydrophobicity, etc.) of the multifunctional coating was achieved by the addition of inorganic (e.g., polysilazane, etc.) and/or PBO to the PI resin.

In another and/or alternative non-limiting aspect of the present disclosure, the multifunctional coating has a unique chemical structure that facilitates a high level of molecular linking with its additive chemistry and/or filler components. These components in the multifunctional coating serve to functionally optimize the multifunctional coating formulation with specific, but highly important, performance properties that may be individual or unique to meet a specific performance requirement(s). Non-limiting examples of such performance requirement include, but are not limited to, elasticity, flexibility, impact resistance, ductility, strength, toughness, elongation, hardness, specific corrosion resistance, chemical resistance, abrasion resistance, hydrolytic stability, density, omniphobic, hydrophobic, non-leaching biocide, anti-static, thermal isolative, thermal conductive, thermochromic, nonstick, self-cleaning foul release, anti-fouling, thermal conductivity, thermal insulating, anti-seize, anti-bacterial, radar absorbing, EMF shielding, hydrophobic properties, and/or omniphobic properties. As a result of the addition of one or more components (e.g., secondary polymeric additive, etc.) and/or fillers to the multifunctional coating, a variety of different highly functional coatings with unique optimized physical, chemical and mechanical performance properties can be created. Non-limiting examples of such multifunctional coatings have: a) resistance to aggressive chemicals and solutions; b) corrosion resistance; c) erosion resistance; d) high-temperature resistance; e) abrasion resistance to dry or wet particles; f) high pressure resistance; g) extreme weather resistance; h) impact resistance; and/or i) low surface energy. Nonlimiting practical examples of the performance properties of the multifunctional coating that can be formulated by the addition of functionalizing components and/or fillers are: a) high hardness coatings that are coupled with resilience as an alternate to metal alloy cladding and linings; b) ultra-smooth foul release coatings coupled with a nano-scaled non-leaching biocide as a next generation marine vessel hull and bottom coating; c) extreme high-temperature corrosion resistance coatings coupled with thermal efficiency as a boiler water wall and superheater tube coating; d) long term particle abrasion resistance coatings coupled with advanced non-stick/release for mineral and grain silos and rail cars; e) high UV resistance coatings coupled with advanced film stability and a molecular level surface bond to resist extreme weather conditions, and/or; f) coatings having thermal film stability and a density for use as a primer in high temperature environments.

In another and/or alternative non-limiting aspect of the present disclosure, the multifunctional coating is highly versatile as it may be applied in multiple forms using multiple application methods and cured using multiple curing mechanisms. In one form, the multifunctional coating composition can optionally be formulated to include a solvent whereby the amount of solvent facilitates in the application of the multifunctional coating (similar to a paint), by use of a brush, pad or conventional spray methods. The choice of applicator or applicators for the multifunctional coating can be determined by the amount of solvent used in the coating composition. As an example, a high solids multifunctional coating composition that contains a small amount of solvent may be applied optimally by spray application. Alternately, a multifunctional coating composition that contains a medium amount of solvent may be optimally applied by spray or brush application. In several possible compositions, the multifunctional coating may contain a large amount of solvent to the extent that a very thin layer may be applied by rag-wiping or pad-wiping or possibly by vapor transmission.

In another and/or alternative non-limiting aspect of the present disclosure, the multifunctional coating can optionally have a coating composition to enable the multifunctional coating to be cured and/or crosslinked using a hardener, chemical curing agent or catalyst, or by use of a UV curative where exposure to a UV light source initiates a crosslinking photochemical reaction. It should be noted that other forms or methods of curing and/or crosslinking of the multifunctional coating can be used such as, but not limited to, moisture curing and/or moisture reacting mechanisms. During curing, crosslinking and/or conversion of the multifunctional coating, the backbone chemistry of the multifunctional coating reacts with OH groups on the surface to create the conditions for molecular bonding. The result of such reactions with the OH groups is to form advanced adhesion between the coating and substrate that greatly enhances film stability and service life of the multifunctional coating.

In another and/or alternative non-limiting aspect of the present disclosure, the multifunctional coating can be optionally formulated and produced in a solid powder or particulate form where it can be mixed with a carrier solvent and sprayed onto the surface of a material and allowed to dry or, alternately, dry sprayed on the surface of a material in an established uniform manner using conventional electrostatic spray application equipment. The applied multifunctional coating in powder form can be cured, crosslinked and/or converted by exposure to heat wherein some or all of the components of the multifunctional coating melts and forms a uniform sealed surface and, by the use of thermal crosslinking mechanisms, cures or converts the multifunctional coating into a solid thermoset performance barrier.

In another and/or alternative non-limiting aspect of the present disclosure, the multifunctional coating can be applied directly to a substrate as a highly durable standalone barrier or coating, or in combination with other functional materials where it acts as a highly effective base layer, tie layer, or top protective layer. The multifunctional coating can be applied to a steel surface to form a strong bond with the steel surface, and also the multifunctional coating can be applied to other metals, wood, plastic, composite, glass, and concrete to form a strong bond with such materials.

It is one non-limiting object of the present disclosure to provide a multifunctional coating that: a) is high temperature resistant; b) has resistance to aggressive chemicals and solutions; c) is corrosion resistant; d) is erosion resistant; e) is abrasion resistant to dry or wet particles; f) is high pressure resistant; g) is extreme weather resistant; h) is impact resistant; and/or i) is has low surface energy.

It is another and/or alternative non-limiting object of the present disclosure to provide a multifunctional coating that is useful where operation at temperatures in excess of 150° C. and up to 350° C. or more is required.

It is another and/or alternative non-limiting object of the present disclosure to provide a multifunctional coating that can replace most applications that require stainless steel and/or high nickel alloy (CRA) clad or lined pipe with little sacrifice in performance and longevity as compared to stainless steel and/or high nickel alloy (CRA) clad or lined pipe.

It is another and/or alternative non-limiting object of the present disclosure to provide a multifunctional coating that is suitable for classes R (220° C.), C (240° C.+) and greater than 250 (250° C.) insulation.

It is another and/or alternative non-limiting object of the present disclosure to provide a multifunctional coating used to prevent corrosion and fouling from marine growth to reduce energy use in shipping by at least 3% by reducing flow resistance.

It is another and/or alternative non-limiting object of the present disclosure to provide a multifunctional coating that remains bio-free over at least 50% of its surface after 9 months of seawater immersion, and where any growth after 12 months can be easily removed without abrasives.

It is another and/or alternative non-limiting object of the present disclosure to provide a multifunctional coating that includes is applied as a sealcoat over an epoxy or other corrosion resistant coating, and which has a contact angle with water of greater than 100°.

It is another and/or alternative non-limiting object of the present disclosure to provide a multifunctional coating that can be used at temperatures of at least 180° C. to replace a corrosion resistant metal cladding in highly acidic environments.

It is another and/or alternative non-limiting object of the present disclosure to provide a multifunctional coating that has a thermal conductivity of at least 0.2 W/m-K, and is thermally stable to at least 250° C., and has with a breakdown strength of at least 500V/mil.

It is another and/or alternative non-limiting object of the present disclosure to provide a multifunctional coating that is used as a thermal interface material and/or adhesive.

It is another and/or alternative non-limiting object of the present disclosure to provide a multifunctional coating that is formed as a thermoplastic film and applied by wrapping or extrusion onto wire or other type of electrical conductor.

It is another and/or alternative non-limiting object of the present disclosure to provide a multifunctional coating that includes: a) one or more polysilazanes; b) one or more secondary polymeric additives (one or more secondary polymeric additives (e.g., siloxane compounds and/or polysilane compounds); c) one or more optional functionalized nanoparticles and/or fillers; d) one or more optional additive polymers that include: i) Polysulfones (PSF) such as Polyethersulfone (PES) and/or Polyphenylene sulfide (PPS); ii) Polyimides (PI); iii) Polybenzimidazole (PBI); iv) Polybenzoxazoles (PBO); and/or v) fluoropolymers; e) one or more optional additives (e.g., biocide, foaming agent, surface tension agent, pigment, curing agent, surface friction reducing agent, stabilizers, flexibilizers, inhibitors, flow control agents, anti-oxidants, degassing agents, dyes, coupling agent, dispersing agents, catalyst and/or hardeners; etc.); and f) one or more optional solvents; and which multifunctional coating is formulated such that it can optionally i) function as a high-temperature insulator, ii) have high elongation and/or improved hydrolytic stability, iii) have extreme weather resistance, iv) have high chemical resistance, v) have high impact and/or abrasion resistance, and/or vi) have improved thermal cycling resistance.

It is another and/or alternative non-limiting object of the present disclosure to provide a multifunctional coating that can be used to a) act as thermal insulators, thereby reducing the high exposure to temperature on the overlying layers, and therefore increasing thermal efficiency of the system while providing the necessary anti-corrosion protection, and/or b) act as a thermal insulator to the underlying layer(s), thereby serving to reduce the cold exposure temperature of the sea water, while possessing the physical properties necessary to resist damage during installation and service.

It is another and/or alternative non-limiting object of the present disclosure to provide a multifunctional coating that can be formulated to resist cracking, delamination, or otherwise maintains integrity from bending forces similar to those experienced in pipelines, downhole OCTG (oil country tubular goods), SAGD (steam-assisted gravity drainage) tubulars, lay barge including reel installation, directional drilled pipe installations.

It is another and/or alternative non-limiting object of the present disclosure to provide a multifunctional coating that can be formulated to resist cracking, delamination, or otherwise maintain integrity from bending forces similar to those experienced in above ground or suspended power lines, high tension cables, and similar to resist ice buildup created by adverse weather conditions.

It is another and/or alternative non-limiting object of the present disclosure to provide a multifunctional coating can be formulated to resist cracking, delamination, or otherwise maintain integrity due to thermal shock or extreme temperature changes.

It is another and/or alternative non-limiting object of the present disclosure to provide a multifunctional coating that is highly useful in withstanding exposure in a number of harsh environments, and/or resistant to a number of mechanical and/or chemical attacks.

It is another and/or alternative non-limiting object of the present disclosure to provide a multifunctional coating that can be used in operation temperatures that are in excess of 150° C.

It is another and/or alternative non-limiting object of the present disclosure to provide a multifunctional coating that can be useful for high temperature deep water pipeline protection.

It is another and/or alternative non-limiting object of the present disclosure to provide a multifunctional coating that can be useful in harsh or aggressive environments such as those experienced in a deep-water oil and gas extraction environment.

It is another and/or alternative non-limiting object of the present disclosure to provide a multifunctional coating that can be used to coat the exterior and/or interior of oil and gas pipe.

It is another and/or alternative non-limiting object of the present disclosure to provide a multifunctional coating that resists very high temperatures (e.g., above 170° C.) and resists the corrosive chemical solutions and/or wet particle abrasion.

It is another and/or alternative non-limiting object of the present disclosure to provide a multifunctional coating that displays the resistance and durability similar to a fluoropolymer with the strength of a ceramic material.

It is another and/or alternative non-limiting object of the present disclosure to provide a multifunctional coating that can replace most applications that require stainless steel and/or high-nickel alloy (CRA) clad or lined pipe.

It is another and/or alternative non-limiting object of the present disclosure to provide a multifunctional coating that can be coated (interior coating and/or exterior coating) on a pipe to form a coated pipe that has the same or similar high-temperature and corrosion resistant-properties of stainless steel and/or high-nickel alloy (CRA) clad or lined pipe.

It is another and/or alternative non-limiting object of the present disclosure to provide a multifunctional coating that can be used on the exterior surface of boat hulls.

It is another and/or alternative non-limiting object of the present disclosure to provide a multifunctional coating that includes additives and chemistry adjustments including a non-leaching biocide where, upon curing, creates an ultra-hard, ultra-smooth surface, and optionally forms a bioresistant surface that resists biological growth on the surface of the coating, and is extremely useful as a high-performance release coating for marine vessels.

It is another and/or alternative non-limiting object of the present disclosure to provide a multifunctional coating that can be used on the interior and/or exterior surfaces of rail hopper cars, silos and/or tanks that transport and store crushed minerals, grain, plastic pellets, etc.

It is another and/or alternative non-limiting object of the present disclosure to provide a multifunctional coating that can resist high abrasion and provide superior non-stick properties.

It is another and/or alternative non-limiting object of the present disclosure to provide a multifunctional coating that i) has high-temperature insulator properties that can be used to a) act as thermal insulators, thereby reducing the high exposure to temperature on the overlying layers, and therefore increasing thermal efficiency of the system while providing the necessary anti-corrosion protection, and/or b) act as a thermal insulator to the underlying layer(s), thereby serving to reduce the cold exposure temperature of the sea water, while possessing the physical properties necessary to resist damage during installation and service, ii) has high elongation and/or hydrolytic stability, iii) has improved weather resistance, iv) has improved chemical resistance, v) has improved impact and/or abrasion resistance, and/or vi) has improved thermal cycling.

It is another and/or alternative non-limiting object of the present disclosure to provide a multifunctional coating that has increased thermal conductivity, increased dielectric strength and/or increased mechanical strength.

It is another and/or alternative non-limiting object of the present disclosure to provide a multifunctional coating that includes fillers that can be used to a) increase thermal conductivity; and/or b) modify a surface area and/or surface energy.

It is another and/or alternative non-limiting object of the present disclosure to provide a multifunctional coating that includes fillers that can be used to reduce contact angles by at least 5°.

It is another and/or alternative non-limiting object of the present disclosure to provide a multifunctional coating that includes fillers that can be used to increase thermal conductivity, modify surface area and/or surface energy, reduce contact area, reduce micro and macro biofouling, reduce or eliminate adhesion of marine growth, add surface texture, enhance toughness, enhance abrasion resistance, increase impact resistance, modify density, increase thermal insulation, improve chemical resistance, and/or increase hardness of the multifunctional coating.

It is another and/or alternative non-limiting object of the present disclosure to provide a multifunctional coating that includes fillers that can be used to form a multifunctional that has a) a high thermal conductivity (greater than 0.2 W-m-K, b) a high dielectric breakdown strength above 500 V/mill, c) a low flow resistance that is lower than epoxy (e.g., at least 5% lower flow resistance than epoxy), d) a contact angle that is greater than 90° for a hydrophobic coating or less than 50° for a hydrophilic coating, e) an oil contact angle of greater than 100°, f) a reduced marine growth or adhesion of at least 20%, and/or g) a scratch resistance pencil hardness (ASTM D3363) of at least 6N.

It is another and/or alternative non-limiting object of the present disclosure to provide a multifunctional coating that includes fillers that can be used to improve surface finish, improve adhesive and/or film stability, improve elasticity, improve flexibility, improve crack resistance, improve impact resistance, improve ductility, improve strength, improve toughness, improve elongation, improve hardness, improve corrosion resistance, improve chemical resistance, improve abrasion resistance, improve hydrolytic stability, modified density, improve omniphobic properties, improve hydrophobic properties, reduce leaching of biocide, improve anti-static properties, improve thermal isolative properties, improve thermal conductiveness, improve thermochromic properties, improve nonstick properties, improve self-cleaning foul release properties, improve anti-fouling properties, improve anti-static properties, improve thermal conductivity properties, improve thermal insulating properties, improve anti-seize properties, improve anti-bacterial properties, improve radar absorbing properties, and/or improve EMF (electromagnetic field) shielding properties.

It is another and/or alternative non-limiting object of the present disclosure to provide a multifunctional coating that includes a filler that includes one or more nanoparticles, nanosheets, and/or nanofibers filler.

It is another and/or alternative non-limiting object of the present disclosure to provide a multifunctional coating that includes fillers that can be used to facilitate in forming, upon the curing of the multifunctional coating, multifunctional coating that has a thin, ultra-hard, ultra-smooth surface with enhanced nonstick/release properties.

It is another and/or alternative non-limiting object of the present disclosure to provide a multifunctional coating that includes additive that can be used to a) assist in flow, b) reduce or eliminate foaming, c) control surface tension, d) add color (e.g., pigment, etc.), e) facilitate in the curing of the multifunctional coating (e.g., curing agent, etc.), f) improve antimicrobial resistance (e.g., biocide additive, etc.), g) reduce foaming, h) reduce surface friction reducing agent, i) stabilizer coating, j) improve flexibility of coating, k) inhibitor certain reactions, 1) catalyze coating reactions, m) harden and/or cure coating, n) inhibit fouling of coating, and/or o) improve dispersement of components in coating.

It is another and/or alternative non-limiting object of the present disclosure to provide a multifunctional coating that includes solvent to facilitate in the mixing together of the components of the multifunctional coating and/or to facilitate in the application of the multifunctional coating to a surface.

It is another and/or alternative non-limiting object of the present disclosure to provide a multifunctional coating that can be applied at thicknesses of at least 0.5 mils.

It is another and/or alternative non-limiting object of the present disclosure to provide a multifunctional coating that can be applied by using conventional paint application methods (e.g., brush, pad or conventional spray methods) or by rag-wiping or pad-wiping or possibly by vapor transmission.

It is another and/or alternative non-limiting object of the present disclosure to provide a multifunctional coating that has a composition to enable the multifunctional coating to be cured and/or crosslinked using a hardener, chemical curing agent or catalyst, or by use of a UV curative where exposure to a UV light source initiates a crosslinking photochemical reaction.

It is another and/or alternative non-limiting object of the present disclosure to provide a multifunctional coating that can be applied directly to a substrate as a highly durable standalone barrier or coating, or in combination with other functional materials where it acts as a highly effective base layer, tie layer, or top protective layer.

It is another and/or alternative non-limiting object of the present disclosure to provide a multifunctional coating that can be applied to a steel surface to form a strong bond with the steel surface, and also the multifunctional coating can be applied to other metals, wood, plastic, composite, glass, and concrete to form a strong bond with such materials.

It is another and/or alternative non-limiting object of the present disclosure to provide a multifunctional coating that includes the addition of functionalizing components (e.g., secondary polymeric additive, etc.) and/or fillers to form a coating that is: a) a high hardness coating that is coupled with resilience as an alternate to metal alloy cladding, linings, etc.; b) a ultra-smooth foul release coating coupled with a nanoscaled non-leaching biocide as a next generation marine vessel hull, bottom coating, etc.; c) an extreme high-temperature corrosion-resistant coating that is coupled with thermal efficiency as a boiler water wall, superheater tube coating, etc.; d) a long term particle abrasion resistance coating that is coupled with advanced non-stick/release for mineral and grain silos, rail cars, etc.; e) a high UV resistance coating coupled with advanced film stability and a molecular level surface bond to resist extreme weather conditions; and/or f) a coating having thermal film stability and a density for use as a primer in high temperature environments, etc.

It is another and/or alternative non-limiting object of the present disclosure to provide a multifunctional coating that optionally includes one or more functional fillers that impart specific performance properties such as, but not limited to, those that act as thermal insulators thereby reducing the high exposure to temperature on the overlying layers, and therefore increasing thermal efficiency of the system while providing the necessary anti-corrosion protection, and/or act as a thermal insulator to the underlying layer(s) thereby serving to reduce the cold exposure temperature of the sea water, while possessing the physical properties necessary to resist damage during installation and service.

It is another and/or alternative non-limiting object of the present disclosure to provide a multifunctional coating that optionally includes nano scaled fillers, components (e.g., secondary polymeric additive, etc.) and chemistry adjustments where upon curing creates a thin, ultra-hard, ultra-smooth surface with enhanced nonstick/release properties that can be applied at thicknesses of at least 0.5 mils.

It is another and/or alternative non-limiting object of the present disclosure to provide a multifunctional coating that is a polysilazane based coating composition that may be applied to a wide range of surfaces, which multifunctional coating is formed from a mixture of constituents comprising polysilazane combined with one or more of select nanoparticle fillers, organic fluoropolymer, polysiloxane and/or polysulfone additions, and one or more additives and/or agents in such an amount and composition to enhance or impart a functional property or properties for the purpose of optimizing the performance of the multifunctional coating.

It is another and/or alternative non-limiting object of the present disclosure to provide a multifunctional coating can include insoluble antimicrobials alone or in combinations with low friction additives to create a surface texture on the multifunctional coating that can reduce marine growth by 10-99.9%, and/or reduce adhesion of marine growth 10-90%.

It is another and/or alternative non-limiting object of the present disclosure to provide a multifunctional coating that includes a polysilazane backbone of at least 10%, a functionalized nanoparticle filler, and secondary polymeric additive, wherein such coating has a temperature resistance of at least 150° C. without degrading and/or deteriorating, and which coating provides one or more additional functionalities such as: a) corrosion resistance; b) high thermal conductivity (e.g., at least 0.11 W-m-K); c) high dielectric breakdown strength of at least 500 V/mil; d) low flow resistance (e.g., >30% lower than an epoxy); e) a contact angle of at least 900 (hydrophobic), or less than 50° (hydrophilic); f) an oil contact angle of greater than 100°; g) reduced marine growth or adhesion of at least 30%; and/or h) a scratch resistant pencil hardness (ASTM D3363) of at least 6N.

It is another and/or alternative non-limiting object of the present disclosure to provide a multifunctional coating that includes functionalized nanoparticles, wherein the functionalized nanoparticles include fluorinated silane, silicone, and/or F-POSS (or precursor) functionalized inorganic particle with at least one dimension less than 100 nm, and the content of the functionalized nanoparticles in the multifunctional coating is least 0.5 wt. %.

It is another and/or alternative non-limiting object of the present disclosure to provide a multifunctional coating that includes trialkoxysilyl-substituted polymethyl/polydimethylsilazane and/or propyltriethoxysilyl-substituted polymethyl(hydro)/polydimethylsilazane.

It is another and/or alternative non-limiting object of the present disclosure to provide a multifunctional coating that is used as a binder for magnetic particles.

It is another and/or alternative non-limiting object of the present disclosure to provide a multifunctional coating that can operate at temperatures in excess of 150° C.; said multifunction coating includes polysilazane, secondary polymeric additive, and one or more of filler, additive polymer and additive; said polysilazane constitutes at least wt. % of said multifunctional coating; said secondary polymeric additive constitutes at least 0.1 wt. % of said multifunctional coating; said secondary polymeric additive includes one or more polymers selected from the group consisting of siloxane compound and polysilane compounds; and wherein said multifunctional coating can i) function as a high-temperature insulator, ii) have high elongation and/or improved hydrolytic stability, iii) have extreme weather resistance, iv) have high chemical resistance, v) have high impact and/or abrasion resistance, and/or vi) have improved thermal cycling resistance.

It is another and/or alternative non-limiting object of the present disclosure to provide a multifunctional coating that includes at least 1 wt. % additive polymer; said additive polymer includes one or more compounds selected for the group consisting of polysulfones, polyimides, polybenzimidazole, polybenzoxazoles and fluoropolymers.

It is another and/or alternative non-limiting object of the present disclosure to provide a multifunctional coating that includes at least 1 wt. % filler; said filler includes one or more of nanoparticles, nanosheets and microspheres.

It is another and/or alternative non-limiting object of the present disclosure to provide a multifunctional coating that includes at least 1 wt. % additive; said additive includes one or more of biocide, foaming agent, surface tension agent, pigment, curing agent, surface friction reducing agent, stabilizers, flexibilizers, inhibitors, flow control agents, anti-oxidants, degassing agents, dyes, coupling agent, dispersing agents, catalyst and hardeners.

It is another and/or alternative non-limiting object of the present disclosure to provide a multifunctional coating that includes one or more compounds selected from the group consisting of trialkoxysilyl substituted polymethyl/polydimethylsilazane, propyltriethoxysilyl-substituted polymethyl (hydro)/polydimethylsilazane.

It is another and/or alternative non-limiting object of the present disclosure to provide a multifunctional coating that includes one or more compounds selected from the group consisting of methylvinylsiloxanes, 1,3-divinyltetramethyldisiloxane, 1,3,5-trivinyl-1,3,5-trimethylcyclotrisiloxane, and 1,3,5,7-tetravinyl-1,3,5,7-tetramethylcyclotetrasiloxane; said polysilane includes one or more compounds selected from the group consisting of tetraethyl-orthosilicate, methyltriethoxysilane, glycidyloxypropyltrimethoxysilane, 3-Aminopropyl triethoxysilane, dimethyl octadecylsilane, trimethoxymethylsilane, poly(dimethylsilylene), cyclopolysilanes, alkyltrihalosilane, trihalosilanes, phenyltrichlorosilane, tertiary butyltrichlorosilane, dodecyltrichlorosilane, poly(ethylene oxide-)-poly(1, 1-dimethyl-2, 2-dihexyldisilene), and poly(dimethylsilanediyl).

It is another and/or alternative non-limiting object of the present disclosure to provide a multifunctional coating that prior to be cured and/or hardened includes solvent; said solvent constitutes at least 1 wt. % of said multifunctional coating.

It is another and/or alternative non-limiting object of the present disclosure to provide a multifunctional coating that is corrosion resistance and has at least one additional functionality selected from the group consisting of a) high thermal conductivity of greater than 0.2 W-m-K, b) high dielectric breakdown strength above 500 V/mil, c) low flow resistance that is more than 30% lower than epoxy, d) a contact angle of greater than 90°, f) an oil contact angle of greater than 100°, g) reduced marine growth or adhesion of at least 30%, and h) a scratch resistance pencil hardness (ASTM D3363) of at least 6N.

It is another and/or alternative non-limiting object of the present disclosure to provide a multifunctional coating that is a high-temperature insulator that can be used to a) act as thermal insulators, thereby reducing the high exposure to temperature on the overlying layers, and therefore increasing thermal efficiency of the system while providing the necessary anti-corrosion protection, and/or b) act as a thermal insulator to the underlying layer(s), thereby serving to reduce the cold exposure temperature of the sea water, while possessing the physical properties necessary to resist damage during installation and service.

It is another and/or alternative non-limiting object of the present disclosure to provide a multifunctional coating that is used to prevent corrosion and fouling from marine growth to reduce energy use in shipping by at least 3% by reducing flow resistance.

It is another and/or alternative non-limiting object of the present disclosure to provide a multifunctional coating that remains bio-free over at least 50% of its surface after 9 months of seawater immersion, and where any growth after 12 months can be easily removed without abrasives.

It is another and/or alternative non-limiting object of the present disclosure to provide a multifunctional coating that is applied as a sealcoat over an epoxy or other corrosion-resistant coating, and which has a contact angle with water of greater than 100°.

It is another and/or alternative non-limiting object of the present disclosure to provide a multifunctional coating that can be used at at least 180° C. to replace a corrosion-resistant metal cladding in highly acidic environments including HCl and H2SO4.

It is another and/or alternative non-limiting object of the present disclosure to provide a multifunctional coating that has a thermal conductivity of at least 0.2 W/m-K, and is thermally stable to at least 250° C., with a breakdown strength of at least 500V/mil.

It is another and/or alternative non-limiting object of the present disclosure to provide a multifunctional coating that is formulated from neat or partially crosslinked resins added with a solvent where the solvent content is 3 to 7 lbs./gallon.

It is another and/or alternative non-limiting object of the present disclosure to provide a multifunctional coating that includes functionalized nanoparticle filler, said functionalized nanoparticle filler includes one or more materials selected from the group consisting of a fluorinated silane, silicone, or F-POSS (or precursor) functionalized inorganic particle with at least one dimension of less than 100 nm, said filler constituting at least 0.5 wt. % of said multifunctional coating.

It is another and/or alternative non-limiting object of the present disclosure to provide a multifunctional coating that includes inorganic fillers and pigments that constitute 1-30 wt. % of said multifunctional coating.

It is another and/or alternative non-limiting object of the present disclosure to provide a multifunctional coating that is used as a binder for magnetic particles.

It is another and/or alternative non-limiting object of the present disclosure to provide a multifunctional coating that is used as a thermal interface material or adhesive.

It is another and/or alternative non-limiting object of the present disclosure to provide a multifunctional coating that is formed as a thermoplastic film and applied by wrapping or extrusion onto a wire or other electrical conductor.

It is another and/or alternative non-limiting object of the present disclosure to provide a multifunctional coating that is formulated from neat or partially cross-linked resins added with a solvent where the solvent content is at least 1 lbs./gallon.

It is another and/or alternative non-limiting object of the present disclosure to provide a multifunctional coating wherein said solvent is absent reactive groups such as hydroxyl or amine groups.

It is another and/or alternative non-limiting object of the present disclosure to provide a multifunctional coating wherein a coating thickness of said multifunctional coating when dried is 0.1 to 20 mils.

It is another and/or alternative non-limiting object of the present disclosure to provide a multifunctional coating that includes functionalized nanoparticle filler, said functionalized nanoparticle filler includes one or more of fluorinated polyhedral oligomeric silsesquioxane (F-POSS), F-POSS (or precursor) functionalized inorganic particle, graphene, graphene oxide, fumed silica nano-ceramics, boron nitride nanosheets, carbon nanotubes, nanoclays, exfoliated nano-fillers, nano-cermets, and nanofibers including conductive nanofibers or other functionalized inorganic particle, said functionalized nanoparticle filler has at least one dimension of less than 100 nm.

It is another and/or alternative non-limiting object of the present disclosure to provide a multifunctional coating that said functionalized nanoparticle filler constitutes at least 0.5 wt. % of said multifunctional coating.

It is another and/or alternative non-limiting object of the present disclosure to provide a multifunctional coating that said functionalized nanoparticle filler is functionalized with a fluorinated silane or silicone.

It is another and/or alternative non-limiting object of the present disclosure to provide a multifunctional coating that includes inorganic fillers and pigments that constitute 1-30 vol. % of said multifunctional coating.

It is another and/or alternative non-limiting object of the present disclosure to provide a multifunctional coating that is formulated in liquid form.

It is another and/or alternative non-limiting object of the present disclosure to provide a multifunctional coating that is formulated in powder form.

It is another and/or alternative non-limiting object of the present disclosure to provide a multifunctional coating that is hardened, converted, initiated, catalyzed, crosslinked, or otherwise cured, including multiple stage curing, by use of chemical catalyst, UV, IR, moisture, and/or thermal mechanisms.

It is another and/or alternative non-limiting object of the present disclosure to provide a multifunctional coating that can be applied by use of a brush, a roller, a pad, a wipe, vapor deposition, deposition, powder spray, and/or sprayer.

It is another and/or alternative non-limiting object of the present disclosure to provide a multifunctional coating that is of sufficient fluid characteristic or viscosity to seal microporosity in the underlying epoxy or other corrosion resistant coating.

It is another and/or alternative non-limiting object of the present disclosure to provide a multifunctional coating that is used to withstand abrasion and adhesive sticking or build-up of granular and particle materials such as plastic pellets, grain and related foodstuffs, ground minerals, and wood chips.

It is another and/or alternative non-limiting object of the present disclosure to provide a multifunctional coating that is applied to the interior of storage tanks, transport tanks, transport hoppers, ship hulls, rail cars, feed hoppers, silos, stacks, ducts, and secondary chemical containment dykes and/or trenches.

It is another and/or alternative non-limiting object of the present disclosure to provide a multifunctional coating that is applied to a wire, an electrical cable, a hose, and/or a flexible pipe.

It is another and/or alternative non-limiting object of the present disclosure to provide a multifunctional coating that is applied to metal, glass, ceramic, concrete, plastics, composites, reinforced composite plastics, and/or thermally resistant composite material

Other aspects, advantages, and novel features of the present disclosure will become apparent from the following detailed description of the disclosure.

### DETAILED DESCRIPTION OF THE DISCLOSURE

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, all the intermediate values and all intermediate ranges).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

The present disclosure relates to functionalized silicone-based coating compositions that are formulated from certain silicone-based polymers combined with optimizing compatible chemistries and functionalized fillers to make high-performance coatings with advanced properties.

The multifunctional coating that can operate at temperatures in excess of 150° C. The multifunction coating includes polysilazane, secondary polymeric additive, and one or more of filler, additive polymer and additive. The polysilazane constitutes at least wt. % of the multifunctional coating. The secondary polymeric additive constitutes at least 0.1 wt. % of the multifunctional coating. The secondary polymeric additive includes one or more polymers selected from the group consisting of siloxane compound and polysilane compounds. The multifunctional coating can i) function as a high-temperature insulator, ii) have high elongation and/or improved hydrolytic stability, iii) have extreme weather resistance, iv) have high chemical resistance, v) have high impact and/or abrasion resistance, and/or vi) have improved thermal cycling resistance.

One non-limiting embodiment, the multifunctional coating can includes a) 3-40 wt. % (and all values and ranges therebetween) polysilazanes, b) 1-50 wt. % (and all values and ranges therebetween) polysiloxane compound and/or polysilane compound, c) optionally 3-60 wt. % (and all values and ranges therebetween) of one or more treated and/or surface functionalized platelet and/or non-platelet nanoparticle fillers having a size of 5-10,000 nm (and all values and ranges therebetween), wherein the filler includes, but is not limited to, fluorinated polyhedral oligomeric silsesquioxane (F-POSS), graphene, graphene oxide, fumed silica nano-ceramics, boron nitride nanosheets, carbon nanotubes, nanoclays, exfoliated nano-fillers, and/or nanofibers including conductive nanofibers, d) optionally 1-30 wt. % (and all values and ranges therebetween) additive polymer such as, but not limited to, a fluoropolymer, polysulfone, polyamide, polyimides, polybenzimidazole, or polybenzobisoazole, and e) optionally 1-40 wt. % (and all values and ranges therebetween) additives used to finished composition to complete its intended service such as, but not limited to, thermosetting or thermoplastic monomers and/or macromers, polymerized silane, oligomers, cyclic, polycyclic, heterocyclic, linear and/or branched polymer resins, crystalline, semi-crystalline, non-crystalline or amorphous thermoplastic or thermosetting resins, non-leaching biocides such as nano selenium, stabilizers, flexibilizers, inhibitors, curing agents including UV curing agents, liquid and solid resin catalysts, hardeners, flow control agents, anti-oxidants, degassing agents, ceramic microspheres, pigments, dyes, and/or dispersing agents.

The multifunctional coating composition may be optionally formulated using primarily dry solid components without the use of solvent where the compounds, functional additives, and curatives or hardener are blended in dry form and combined using a high-speed mixer. The mixed dry composition can be fed through an extrusion blender or equal thermal process at a preestablished temperature generally 50° C.-100° C. (and all values and ranges therebetween). Because of the fast operation of the extruder and relatively low temperature within the barrel, the composition which includes the curing agent(s) or hardener components will not undergo a significant chemical reaction. The multifunctional coating composition can be produced in pellet, bead or chip form, where it is ground using high speed grinders to a particle size generally less than 150 microns. Alternately, the curing agent(s) or hardener may be produced in powder form and dry blended or mixed separately and added to the ground composition in a separate blending process. Several types of curing agents or hardeners may be used either together or separately depending upon the composition and the additives. The selection of the curing agent(s) or hardener can have a significant impact on the cross-linking density, chemical resistance, brittleness, flexibility, etc. The powdered multifunctional coating composition can be applied to a prepared steel surface using conventional electrostatic spray at a thickness generally between 0.5 mils (12.5 microns and 20+ mils (500+ microns) (and all values and ranges therebetween). The steel surface is generally heated to a temperature of 210° C. to 240° C. (and all values and ranges therebetween) where the applied powder composition melts and solidifies to form a uniform dense protective layer.

Non-limiting examples of the multifunctional coating composition are set forth as follows in weight percent:

| Component | Ex. 1 | Ex. 2 | Ex. 3 |
|---|---|---|---|
| Polysilazane | 3-50% | 10-50% | 10-45% |
| Secondary polymeric | 0.1-50% | 0.1-50% | 0.1-50% |
| additive | | | |
| Filler | 0-60% | 2-60% | 3-60% |
| Additive polymer | 0-40% | 1-40% | 1-40% |
| Additive | 0-40% | 1-40% | 1-40% |
| Solvent | 1-50% | 1-50% | 1-50% |
| Component | Ex. 4 | Ex. 5 | Ex. 6 |
| Polysilazane | 20-40% | 20-35% | 25-35% |
| Secondary polymeric | 1-30% | 2-30% | 5-25% |
| additive | | | |
| Filler | 3-50% | 4-40% | 5-30% |
| Additive polymer | 1-30% | 2-30% | 5-25% |
| Additive | 1-20% | 1-20% | 1-15% |
| Solvent | 5-40% | 10-40% | 10-35% |
| Component | Ex. 7 | Ex. 8 | Ex. 9 |
| Durazane ™ 1500 Fast Cure | 20-35% | 20-35% | 20-35% |
| Polysilane | 10-35% | 10-30% | 12-30% |
| Nanoparticles (e.g., | 2-25% | 5-20% | 5-15% |
| silica, carbon, metal, | | | |
| carbon nanofiber) | | | |
| Polyimide or | 8-30% | 10-30% | 10-25% |
| Fluoropolymer | | | |
| Additive (e.g., coupling | 1-20% | 1-20% | 1-15% |
| agent, pigment, biocide, | | | |
| antifoaming agent, flow | | | |
| agent, surface tension | | | |
| agent, etc.) | | | |
| Solvent | 10-40% | 15-40% | 15-35% |

In Examples 1-9, it will be appreciated that all of the above ranges include any value between the range and any other range that is between the ranges set forth above.

### Example 10

A multifunctional coating that is formulated to seal and protect high temperature steel surfaces up to 350° C. from corrosion commonly experienced under thermal insulation barriers. The multifunctional coating is formed of at least 30 wt. % polysilazane resin such as Durazane™ 1500 fast cure, at least 0.2 wt. % fluorosilane coupling agent such as Novec™ 1720, at least 10 wt. % polyimide such as compounded heterocyclic polyimide, at least 10 wt. % surface treated AL nanocomposite powder, at least 2 wt. % treated carbon nanofiber, at least 30 wt. % low moisture organic solvent such as ethyl acetate, butyl acetate, propylene glycol methyl ether acetate or fluoruos solvent, optionally at least 2 wt. % dicumyl peroxide as a curing agent, and optionally 1-2 wt. % additives to assist in flow, eliminate foaming, control surface tension, pigments, or as commonly used in the general practice. This unique multifunctional coating displays excellent physical and mechanical properties such as hardness, flexibility, impact resistance, adhesion, permeation resistance and chemical resistance. The multifunctional coating can be applied to a surface by spray or brush at a thickness ranging on average from 1.5 mils to 5 mils, allowed to dry, and thermally cures at a temperature greater than 250° C. (which can be achieved by an oven, induction heating, or in maintenance situations putting into service).

### Example 11

A multifunctional coating can be formulated to resist growth of marine organisms while providing a smooth, high wear resistant, omniphobic to near super hydrophobic protective surface coating for marine vessels. The multifunctional coating is formed of at least 25 wt. % polysilazane such as Durazane™ 1500 fast cure, at least 10 wt. % polymerized polysilane, at least 10 wt. % fluorinated ethylene propylene (FEF), at least 0.2 wt. % fluorosilane coupling agent such as Novec™ 1720, at least 5 wt. % treated silica nanoparticles, at least 2 wt. % non-leaching biocide such treated selenium nanoparticles, at least 20 wt. % low moisture organic solvent such as ethyl acetate, butyl acetate, propylene glycol methyl ether acetate or fluoruos solvent, and optionally 1-2 wt. % additives to assist in flow, eliminate foaming, control surface tension, pigments, and at least 2 wt. % catalyst/hardening agent such as 1,8-Diazabicyclo(5.4.0)undec-7-ene (DBU).

### Example 12

A multicomponent coating similar to Example 1 wherein a hardening agent is additionally added. The hardening can be added just prior to the application of the multifunctional coating to a surface. A hardening agent such as, but not limited to, at least 2 wt. % catalyst/hardening agent such as 1,8-Diazabicyclo(5.4.0)undec-7-ene (DBU). This multifunctional coating can be applied by spray or brush at a thickness ranging on average from 3 mils to 8 mils and allowed to cure for at least 8 hours at an average temperature of 21° C. prior to immersion.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure which, as a matter of language, might be said to fall therebetween. The disclosure has been described with reference to the preferred embodiments. These and other modifications of the preferred embodiments, as well as other embodiments of the disclosure, will be obvious from the disclosure herein, whereby the foregoing descriptive matter is to be interpreted merely as illustrative of the disclosure and not as a limitation. It is intended to include all such modifications and alterations insofar as they come within the scope of the appended claims.

What is claimed:

1. A multifunctional coating that can operate at temperatures in excess of 150° C.; said multifunction coating includes polysilazane, secondary polymeric additive, and one or more of filler, additive polymer and additive; said polysilazane constitutes at least wt. % of said multifunctional coating; said secondary polymeric additive constitutes at least 0.1 wt. % of said multifunctional coating; said secondary polymeric additive includes one or more polymers selected from the group consisting of siloxane compound and polysilane compounds; and wherein said multifunctional coating can i) function as a high-temperature insulator, ii) have high elongation and/or improved hydrolytic stability, iii) have extreme weather resistance, iv) have high chemical resistance, v) have high impact and/or abrasion resistance, and/or vi) have improved thermal cycling resistance.

2. The multifunctional coating as defined in claim 1, wherein said multifunctional coating includes at least 1 wt. % additive polymer; said additive polymer includes one or more compounds selected for the group consisting of polysulfones, polyimides, polybenzimidazole, polybenzoxazoles and fluoropolymers.

3. The multifunctional coating as defined in claim 1, wherein said multifunctional coating includes at least 1 wt. % filler; said filler includes one or more of nanoparticles, nanosheets and microspheres.

4. The multifunctional coating as defined in claim 1, wherein said multifunctional coating includes at least 1 wt. % additive; said additive includes one or more of biocide, foaming agent, surface tension agent, pigment, curing agent, surface friction reducing agent, stabilizers, flexibilizers, inhibitors, flow control agents, anti-oxidants, degassing agents, dyes, coupling agent, dispersing agents, catalyst and hardeners.

5. The multifunctional coating as defined in claim 1, wherein said polysilazane includes one or more compounds selected from the group consisting of trialkoxysilyl substituted polymethyl/polydimethylsilazane, propyltriethoxysilyl-substituted polymethyl (hydro)/polydimethylsilazane.

6. The multifunctional coating as defined in claim 1, wherein said siloxane includes one or more compounds selected from the group consisting of methylvinylsiloxanes, 1,3-divinyltetramethyldisiloxane, 1,3,5-trivinyl-1,3,5-trimethylcyclotrisiloxane, and 1,3,5,7-tetravinyl-1,3,5,7-tetramethylcyclotetrasiloxane; said polysilane includes one or more compounds selected from the group consisting of tetraethyl-orthosilicate, methyltriethoxysilane, glycidyloxypropyltrimethoxysilane, 3-Aminopropyl triethoxysilane, dimethyl octadecylsilane, trimethoxymethylsilane, poly(dimethylsilylene), cyclopolysilanes, alkyltrihalosilane, trihalosilanes, phenyltrichlorosilane, tertiary butyltrichlorosilane, dodecyltrichlorosilane, poly(ethylene oxide-)-poly(1, 1-dimethyl-2, 2-dihexyldisilene), and poly(dimethylsilanediyl).

7. The multifunctional coating as defined in claim 1, wherein said multifunctional coating prior to be cured and/or hardened includes solvent; said solvent constitutes at least 1 wt. % of said multifunctional coating.

8. The multifunctional coating as defined in claim 1, wherein said multifunctional coating is corrosion resistance and has at least one additional functionality selected from the group consisting of a) high thermal conductivity of greater than 0.2 W-m-K, b) high dielectric breakdown strength above 500 V/mil, c) low flow resistance that is more than 30% lower than epoxy, d) a contact angle of greater than 90°, f) an oil contact angle of greater than 100°, g) reduced marine growth or adhesion of at least 30%, and h) a scratch resistance pencil hardness (ASTM D3363) of at least 6N.

9. The multifunctional coating as defined in claim 1, wherein said multifunctional coating is a high-temperature insulator that can be used to a) act as thermal insulators, thereby reducing the high exposure to temperature on the overlying layers, and therefore increasing thermal efficiency of the system while providing the necessary anti-corrosion protection, and/or b) act as a thermal insulator to the underlying layer(s), thereby serving to reduce the cold exposure temperature of the sea water, while possessing the physical properties necessary to resist damage during installation and service.

10. The multifunctional coating as defined in claim 1, wherein said multifunctional coating is used to prevent corrosion and fouling from marine growth to reduce energy use in shipping by at least 3% by reducing flow resistance.

11. The multifunctional coating as defined in claim 1, wherein said multifunctional coating remains bio-free over at least 50% of its surface after 9 months of seawater immersion, and where any growth after 12 months can be easily removed without abrasives.

12. The multifunctional coating as defined in claim 1, wherein said multifunctional coating is applied as a sealcoat over an epoxy or other corrosion-resistant coating, and which has a contact angle with water of greater than 100°.

13. The multifunctional coating as defined in claim 1, wherein said multifunctional coating can be used at at least 180° C. to replace a corrosion-resistant metal cladding in highly acidic environments including HCl and H₂SO₄.

14. The multifunctional coating as defined in claim 1, wherein said multifunctional coating has a thermal conductivity of at least 0.2 W/m-K, and is thermally stable to at least 250° C., with a breakdown strength of at least 500V/mil.

15. The multifunctional coating as defined in claim 1, wherein said multifunctional coating is formulated from neat or partially crosslinked resins added with a solvent where the solvent content is 3 to 7 lbs./gallon.

16. The multifunctional coating as defined in claim 1, wherein said multifunctional coating includes functionalized nanoparticle filler, said functionalized nanoparticle filler includes one or more materials selected from the group consisting of a fluorinated silane, silicone, or F-POSS (or precursor) functionalized inorganic particle with at least one dimension of less than 100 nm, said filler constituting at least 0.5 wt. % of said multifunctional coating.

17. The multifunctional coating as defined in claim 1, wherein said multifunctional coating includes inorganic fillers and pigments that constitute 1-30 wt. % of said multifunctional coating.

18. The multifunctional coating as defined in claim 1, wherein said multifunctional coating is used as a binder for magnetic particles.

19. The multifunctional coating as defined in claim 1, wherein said multifunctional coating is used as a thermal interface material or adhesive.

20. The multifunctional coating as defined in claim 1, wherein said multifunctional coating is formed as a thermoplastic film and applied by wrapping or extrusion onto a wire or other electrical conductor.

21. The multifunctional coating as defined in claim 1, wherein said multifunctional coating is formulated from neat or partially cross-linked resins added with a solvent where the solvent content is at least 1 lbs./gallon.

22. The multifunctional coating as defined in claim 21, wherein said solvent is absent reactive groups such as hydroxyl or amine groups.

23. The multifunctional coating as defined in claim 1, wherein a coating thickness of said multifunctional coating when dried is 0.1 to 20 mils.

24. The multifunctional coating as defined in claim 1, wherein said multifunctional coating includes functionalized nanoparticle filler, said functionalized nanoparticle filler includes one or more of fluorinated polyhedral oligomeric silsesquioxane (F-POSS), F-POSS (or precursor) functionalized inorganic particle, graphene, graphene oxide, fumed silica nano-ceramics, boron nitride nanosheets, carbon nanotubes, nanoclays, exfoliated nano-fillers, nano-cermets, and nanofibers including conductive nanofibers or other functionalized inorganic particle, said functionalized nanoparticle filler has at least one dimension of less than 100 nm.

25. The multifunctional coating as defined in claim 24, wherein said functionalized nanoparticle filler constitutes at least 0.5 wt. % of said multifunctional coating.

26. The multifunctional coating as defined in claim 24, wherein said functionalized nanoparticle filler is functionalized with a fluorinated silane or silicone.

27. The multifunctional coating as defined in claim 1, wherein said multifunctional coating includes inorganic fillers and pigments that constitute 1-30 vol. % of said multifunctional coating.

28. The multifunctional coating as defined in claim 1, wherein said multifunctional coating is formulated in liquid form.

29. The multifunctional coating as defined in claim 1, wherein said multifunctional coating is formulated in powder form.

30. The multifunctional coating as defined in claim 1, wherein said multifunctional coating hardened, converted, initiated, catalyzed, crosslinked, or otherwise cured, including multiple stage curing, by use of chemical catalyst, UV, IR, moisture, and/or thermal mechanisms.

31. The multifunctional coating as defined in claim 1, wherein said multifunctional coating can be applied by use of a brush, a roller, a pad, a wipe, vapor deposition, deposition, powder spray, and/or sprayer.

32. The multifunctional coating as defined in claim 1, wherein said multifunctional coating is of sufficient fluid characteristic or viscosity to seal microporosity in the underlying epoxy or other corrosion resistant coating.

33. The multifunctional coating as defined in claim 1, wherein said multifunctional coating is used to withstand abrasion and adhesive sticking or build-up of granular and particle materials such as plastic pellets, grain and related foodstuffs, ground minerals, and wood chips.

34. The multifunctional coating as defined in claim 1, wherein said multifunctional coating is applied to the interior of storage tanks, transport tanks, transport hoppers, ship hulls, rail cars, feed hoppers, silos, stacks, ducts, and secondary chemical containment dykes and/or trenches.

35. The multifunctional coating as defined in claim 1, wherein said multifunctional coating is applied to a wire, an electrical cable, a hose, and/or a flexible pipe.

36. The multifunctional coating as defined in claim 1, wherein said multifunctional coating is applied to metal, glass, ceramic, concrete, plastics, composites, reinforced composite plastics, and/or thermally resistant composite material.
